(19) United States
(12) Patent Application Publication
(10) Pub. No.: US 2004/0060183 A1
(43) Pub. Date: Apr. 1, 2004

(54) Tile measurement apparatus

(76) Inventor: Shalem Moas, Las Vegas, NV (US)

Correspondence Address: Kamran Fattahi, Esq., Law Offices of Kamran Fattahi, (Bldg.2) Suite 330, 6345 Balboa Blvd., Encino, CA, 91316, US

(21) Appl. No.: 10/256,570

(22) Filed: Sep. 27, 2002

(51) Int. Cl. G01B 5/14

(52) U.S. Cl. 33/526

(57) ABSTRACT

A device for measurement and marking of standard sized and shaped tiles for creation of custom tiles with a variety of shapes and sizes for placement adjacent obstructions in hard-to-fit spaces, the device comprising of an elongated rod, a triangularly shaped reference member moveably secured between a proximal and near a distal end of the rod, and an edge marking member having a variety of shapes that is rotatably secured at or near the distal end of the rod. The reference member establishes a reference position for the placement of the device in relation to other already installed tiles, and the edge marking member is used to measure and mark the shape and size of the particular custom tile for fitting adjacent or between other standard tiles and/or objects such as walls, cabinets or the like.

### BACKGROUND OF THE INVENTION

The present invention relates to measuring devices, and more particularly, to a tile measuring apparatus for use in cutting and laying appropriately sized and shaped tiles for placement adjacent obstructions in hard to fit spaces.

Tiles made from various materials such as granite, marble, ceramic, and plastic are used as popular floor coverings by professionals and do-it-yourselfers. Laying pre-cut tiles that are of standard size and shape (usually square or rectangular) side-by-side and away from any obstructions is the easier part of a floor tile installation project. However, when the tile setter approaches an obstruction such as a wall, a cabinet, or a column, where a full size tile cannot be placed therein, a tile having a “custom” size and shape needs to be cut from a standard tile to fit next to the obstruction. The task of cutting a custom tile is usually difficult, time consuming, and somewhat inaccurate, even when performed by professionals. These drawbacks often mean increased labor cost, increased material cost to cover the mistakes, and less than desirable results in that the custom tile may not have the right dimensions or shape to make a seamless fit with good appearance.

Accordingly, there is a need for an improved tool or device that can be used easily, accurately, quickly, inexpensively, and with a high degree of flexibility and versatility to measure and mark standard tiles that can then be cut to various appropriate sizes and shapes to provide a custom fit adjacent other tiles and/or obstructions. The present invention fulfills these needs and provides other related advantages.

### SUMMARY OF THE INVENTION

The present invention resides in a device that can be used to measure and mark standard tiles (usually shaped in square or rectangular forms) which can then be cut to create custom tiles that can have a variety of shapes and sizes for placement adjacent obstructions in hard-to-fit spaces. The device comprises of an elongated rod, a reference member moveably secured between a proximal and distal end of the rod, and an edge marking member having a variety of shapes that is rotatably secured at or near the distal end of the rod. The reference member is used for establishing a reference position for the placement of the device in relation to other already installed tiles, and the edge marking member is used to measure and mark the shape and size of the particular custom tile that must fit adjacent or between other standard tiles and/or objects such as walls, cabinets or the like that pose as obstructions.

The reference member is secured to the elongated rod such that it can slide along the length of the elongated rod from its proximal end to near its distal end. The reference member is positioned along the rod such that it is further away from the distal end of the rod that the edge marking member. The reference member is triangular in shape, and depending on the particular custom tile that needs to be made, it can be turned in one of two directions (forward or backward) along the elongated rod. The function of the edge marking member is to allow the device to be positioned along one of the edges of an already installed tile, or at the intersection of two adjacent but perpendicularly installed tiles, such that a reference position for the placement of the edge marking member of the device is created. When the reference member is appropriately positioned in relation to the other already installed tiles, its position is set by use of a wing nut that tightens the reference member to the rod.

The device of the invention includes several choices of differently shaped edge marking members, wherein the shapes are designed to maximize the number of shapes and angles that most commonly are encountered when the need for constructing custom tiles arises. For example, the edge marking member can have one of several shapes such as a straight edge, a triangle, a round or curved shape, and other shapes of interest are also possible. Whichever shape of an edge marking member is chosen, it is rotatably secured to the elongated rod at or near the distal end of the rod by use of another wing nut. As will be described in further detail below, the desired edge marking member is chosen and properly positioned and secured in place to match the shape, angle, and orientation of the object that is creating the obstruction. This would enable one to later place the device over a full size tile having the reference member placed along one edge or corner of the full size tile, followed by marking or scoring the tile along the edge of the marking member, and cutting the tile along the marking line to create a tile with a custom shape and size that would fit adjacent the obstruction.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a plan view of a tile measurement device embodying the present invention, wherein the device is shown with a straight shaped edge marking member and the reference member shown in two different positions to measure and mark two differently shaped/sized custom tiles;

FIG. 2 is a plan view of the tile measurement device of the invention, wherein the device is shown with a triangular shaped edge marking member and the reference member shown in two different positions so as to measure and mark two differently shaped/sized custom tiles;

FIG. 3 is a plan view of the tile measurement device of the invention, wherein the device is shown with a curved shaped edge marking member and the reference member, each in two different positions so as to measure and mark two differently shaped/sized custom tiles;

FIG. 4 is a top perspective view of the device similar to that shown in FIG. 1;

FIG. 5 is an exploded perspective view of the device shown in FIG. 4, with the reference member shown in its two possible forward and backward positions;

FIG. 6 is a top perspective view of the device similar to that shown in FIG. 2;

FIG. 7 is an exploded perspective view of the device shown in FIG. 6, with the reference member shown in its two possible forward and backward positions;

FIG. 8 is a top perspective view of the device similar to one of the positions shown in FIG. 3;

FIG. 9 is an exploded perspective view of the device shown in FIG. 8, with the reference member shown in its two possible forward and backward positions;

FIG. 10 is a top perspective view of the device similar to the other one of the positions shown in FIG. 3;

FIG. 11 is an exploded perspective view of the device shown in FIG. 10, with the reference member shown in its two possible forward and backward positions

### DETAILED DESCRIPTION OF THE PREFERRED EMBODIMENTS

As shown in the drawings for purposes of illustration, the present invention is concerned with a measurement and marking device used for making custom tiles to properly fit within imperfect, odd, or non-standard shaped or sized spaces adjacent various obstructions that are commonly encountered in tile installation projects.

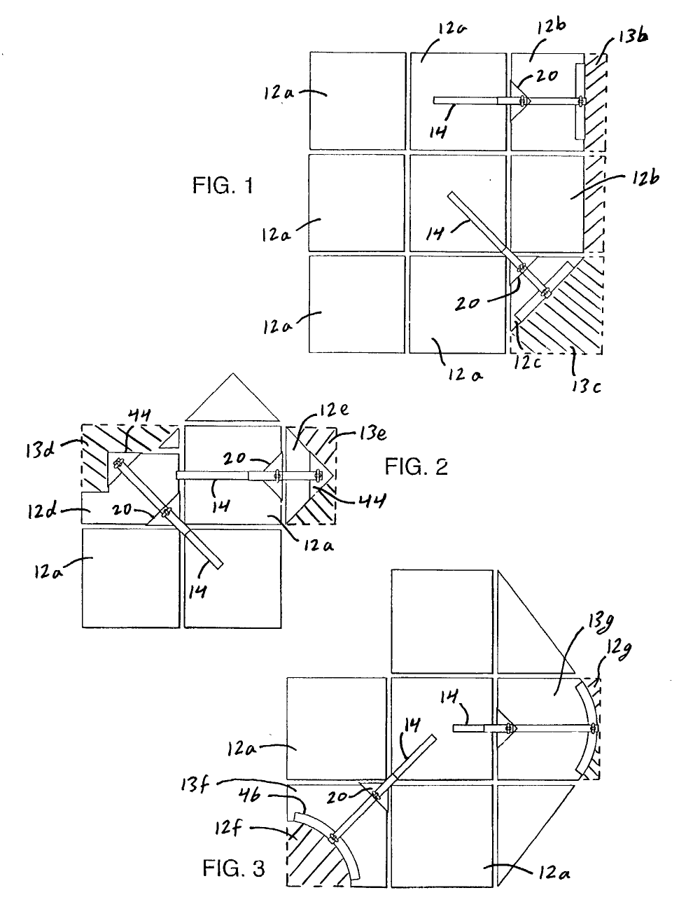

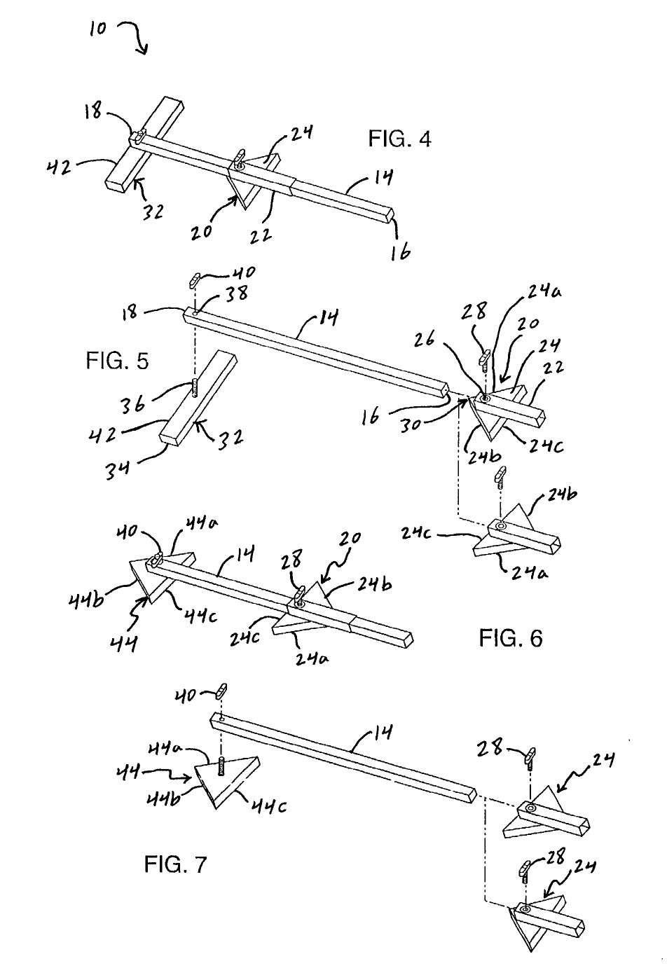

A tile measurement device 10 is illustrated in FIGS. 4 and 5, and the device is shown in its operational environment in FIG. 1, wherein a plurality of six standard sized tiles 12a and several custom tiles 12b and 12c that have been created using the device of the invention to fit adjacent two differently shaped obstructions 13b and 13c are shown for illustrative purposes. Referring to FIGS. 4 and 5, the device has an elongated rod 14, which in its preferred embodiment has a ½ inch by ½ inch square cross section and a length of approximately 20 to 30 inches. Other suitable lengths and dimensions can also be used. The rod 14 has a proximal end 16 and a distal end 18.

A reference member 20 has a hollow elongated portion 22 matching the cross-section of the elongated rod 14, and a triangular portion 24 which is joined to the elongated portion 22 along the lower side thereof such that the triangular portion 24 is positioned below the hollow elongated portion 22. The reference member is moveably placed along the rod 14 by sliding the hollow elongated portion 24 over the rod 14, which will place the triangular portion 24 below the rod 14. A threaded hole 26 is provided on the upper side of the hollow elongated portion 22 of the reference member, and a wing nut 28 is used to tighten and secure the reference member 20 at a desired position along the elongated rod 14. The triangular portion 24 has two sides 24a and 24b that are substantially perpendicular to one another and their intersection forms a pointed tip 30 opposite of the third side 24c. This form of the triangular portion 24 (with two sides that are at right angles to one another) can be used in situations where the tiles also have perpendicular sides such as in the case of square or rectangular tiles. Although not shown in the drawings, it should be noted that in other situations where the tiles are for example diamond shaped, the triangular portion 24 of the reference member 20 can be shaped to have two of its sides (24a and 24b) forming appropriate angles that are less or greater than ninety degrees so as to match the angles of the diamond shaped tiles.

As shown in FIG. 5, the reference member 20 can be placed along the rod 14 in one of two orientations: a forward position with the tip 30 pointing toward the distal end 18 of the elongated rod 14; and a backward position where the tip 30 points toward the proximal end 16 of the rod 14.

The device includes an edge marking member 32 having a variety of desired shapes. In one alternative embodiment shown in FIG. 1 and FIGS. 4-5, the edge marking member 32 is formed of a rectangular plate 34 that is positioned below the surface of the rod 14 and rotatably secured to the distal end 18 of the rod 14 via a threaded bolt 36 inserted through a hole 38 located at or near the distal end 18 of the rod 14 and a wing nut 40 that is tightened around the bolt 36. The thickness of the rectangular plate 34 is the same as the thickness of the triangular portion 24 of the reference member 20 such that when the edge marking member 32 is secured to the rod 14, it is placed at the same level below the rod 14 as the triangular portion 24 of the reference member 20.

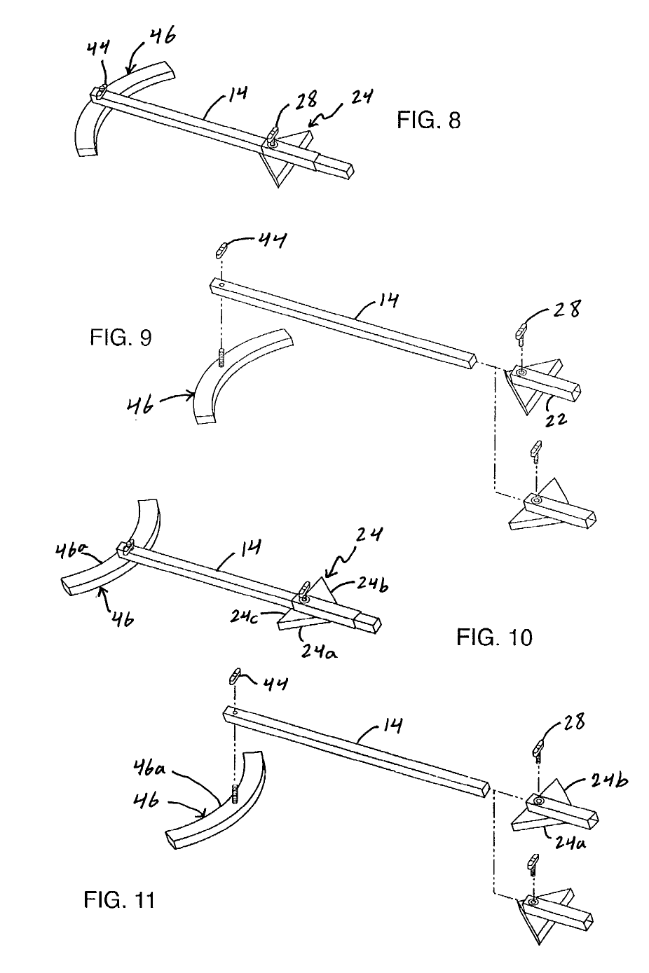

The edge marking member 32 has alternative embodiments in different shapes, three of which are shown in FIGS. 4-5 (straight), FIGS. 6-7 (triangular), and FIGS. 8-11 (curved). Each embodiment is used in different settings as described in the following operational descriptions of the present invention, but other alternative shapes for the edge marking member may also be utilized to match the needs of the particular tile laying project depending on the shape of the desired custom tile as dictated by the interface between various objects that pose as obstructions.

In operation, with reference to the first alternative embodiment of the device shown in FIG. 1 and FIGS. 4-5, the edge marking member 32 is shaped in the form of a rectangle having an exterior straight edge 42, which can be used to measure and mark a custom tile to fit within the space created between an already installed standard or full size tile and an obstruction such as a straight wall. As shown in the upper right corner of FIG. 1, an obstruction such as a straight wall 13b is shown to create a rectangular space between the obstruction 13b and the adjacent full size tile 12a (shown as the middle tile in the top row of tiles in FIG. 1), wherein the rectangular space is smaller than the dimensions of a full size tile. To accommodate this situation, in projects where tiles are set without any grout therebetween, after the full size tile 12a that is adjacent the obstruction is set in place, the reference member 20 is placed in a forward position with its third side 24c parallel to and along the outer edge of the full size tile 12a. It is noted that in projects where grout is used between tiles, a pair of readily available plastic spacers (not shown) are temporarily placed between the third side 24c and the outer edge of the full size tile. As known by those skilled in the art, such plastic spacers are dimensioned and used to simulate the desired space that will be occupied by grout material that is later placed between the tiles to further secure them in place. With the reference member 20 positioned as described, the rod 14 is slidably moved through the elongated portion 22 of the reference member until the exterior straight edge 42 of the edge marking member 32 is parallel to and in contact with the edge of the obstruction 13b. It should be noted that alternatively, the edge marking member could first be positioned against the obstruction followed by positioning the reference member along the edge of the full size tile. In other words, the order is not critical. At such time, the user makes sure that both wing nuts 28 and 40 are tightened so as to secure the relative positions of the reference member 20 and the edge marking member 32. Thereafter, the device 10 is moved and placed on a new, yet uninstalled full size tile, and the third side 24c of the reference member is positioned alongside of one edge of the full size tile. Then, a marking or scoring line is drawn on the full size tile along the line where the exterior straight edge 42 of the edge marking member 32 is located. This marking or line defines where the full size tile must be cut by an appropriate tool known to those skilled in the art of laying tile, thus creating a custom tile which would nicely fit in the space between the pre-installed full tile 12a and the obstruction 13b.

Another application of the device with the straight edge marking member is illustrated in the lower right portion of FIG. 1. In this application, the device is used to create a custom tile having a triangular shape to fit in a space defined by a full size tile 12a on one side, another custom tile 12b on a second side, and an obstruction 13c on a third side. To accommodate this situation, with reference to the lower right portion of FIG. 1, the triangular shaped reference member 20 having two substantially perpendicular sides 24a and 24b is positioned along the rod 14 in its backward position such that the two sides 24a and 24b are placed in the corner at the intersection of the full tile 12a and the custom tile 12b, followed by positioning the exterior straight edge 42 of the edge marking member 32 against the obstruction 13c. If the project calls for use of grout between the tiles, as described above, plastic spacers are temporarily placed between each of the sides 24a and 24b and the two tiles 12a and 12b; otherwise, no plastic spacers are used. Thereafter, wing nuts 28 and 40 are again tightened, and the device is moved and placed over an uninstalled full size tile, the two sides 24a and 24b of the reference member are placed along the edges in one corner of the tile, and a marking or scoring line is drawn on the tile along the exterior straight edge 42 of the marking member. The tile is then cut along the marking or scoring line to create a custom tile which will fit in the space between the two tiles 12a and 12b and the obstruction 13c.

A second alternative embodiment of the device is illustrated in FIG. 2 and FIGS. 6-7, wherein the edge marking member 44 is triangularly shaped. The left middle portion of FIG. 2 shows one application of this embodiment where the device is used to create a custom tile having rectangular portions of two sides of a square shaped tile removed therefrom. To accomplish this, the reference member 20 is positioned in its backward position with the two perpendicular sides 24a and 24b placed in the corner at the intersection of the two full size tiles 12a, followed by positioning the triangular edge marking member 44 with its two substantially perpendicular sides 44a and 44b placed against the obstruction 13d. The wing nuts 28 and 40 are then tightened, and the device is moved and placed over an uninstalled full size tile in a similar manner as described before, and the tile is marked or scored along the exterior edges 44a and 44b of the marking member 44. Once this tile is cut along the scoring lines, it will result in a custom tile 12d that will fit in the space between the full size tiles 12a and the obstruction 13d.

In the right middle portion of FIG. 3, and with reference to FIGS. 6-7, is shown another application. Here, the triangular reference member 20 is in its backward position and its third side is placed along the full size tile 12a and edges 44a and 44b of the triangular edge marking member 44 is positioned against the obstruction 13e. Once the wing nuts 28 and 40 are tightened and the device is moved and placed over another uninstalled tile, it can be scored and cut to create a triangular custom tile 12e.

A third alternative embodiment of the device is illustrated in FIG. 3 and FIGS. 8-11, wherein a curved edge marking member 46 is used. In the left lower portion of FIG. 3 is shown one application of this embodiment where a custom tile can be created to fit adjacent an obstruction 12f such as a round or circular column. The reference member 20 is again in its backward position and placed with its two perpendicular sides 24a and 24b in the corner at the intersection of the two full tiles 12a, followed by positioning the exterior edge 46a of the curved marking member 46 against the obstruction 12f. The device is then used as described before to score and then cut a custom tile 13f to fit adjacent the round obstruction or column 12f.

With reference to the right middle portion of FIG. 3, another application of the third alternative embodiment is shown to create a custom tile that would fit adjacent another differently shaped curved obstruction 12g. For this application, the same curved marking member 46 is used, but it is rotated about the rod 14 such that the center of curvature of the marking member 46 is located between the marking member 46 and the reference member 20. The process of measuring and marking a custom tile 13g for this application is similar to that explained in the previous paragraph and can easily be understood by reference to FIG. 3.

It will be appreciated by the reader that the invention provides several advantages. The invention is simple in design, has very few parts, is relatively inexpensive to manufacture, is versatile and flexible in that it can be used to create many differently shaped and sized custom tiles, and the device is used both as a tool for measuring and marking the targeted custom tiles.

Although several embodiments have been described in detail for purposes of illustration, various modifications may be made without departing from the scope and spirit of the invention. Accordingly, the invention is not to be limited, except as by the appended claims.

What is claimed is:

1. A tile measurement device for use in measuring and marking a custom tile to properly fit adjacent a first tile and an obstruction, comprising:
an elongated bar;
a reference member slidably secured to said elongated bar, wherein said reference member is triangularly shaped having three sides which are used for fixing the position of said device relative to said first tile;
a marking member rotatably secured to said elongated bar for placement adjacent said obstruction to define the position and shape of said custom tile relative to said first tile and said obstruction.

2. The device in claim 1, wherein two of said three sides of said reference member are substantially perpendicular to one another.

3. The device in claim 1, wherein said marking member has an exterior edge that is shaped in a straight line.

4. The device in claim 1, wherein said marking member has an exterior edge that is triangularly shaped.

5. The device in claim 1, wherein said marking member has an exterior edge that is shaped in a curved line.

6. The device in claim 1, wherein said reference member is slidably fixed to said elongated bar by a wing nut.

7. The device in claim 1, wherein said marking member is rotatably fixed to said elongated bar by a wing nut.

8. The device in claim 1, wherein said reference member is extendable from a proximal end of said elongated bar to
